(19) United States
(12) Patent Application Publication
(10) Pub. No.: US 2023/0259676 A1
(43) Pub. Date: Aug. 17, 2023

(54) SCALING METHOD BASED ON A POINTWISE SUPERPOSITION PROCEDURE AND SYSTEM THEREOF

(71) Applicant: NUOVO PIGNONE TECNOLOGIE - SRL, Florence (IT)

(72) Inventors: Marco PALLADINO, Florence, Firenze (IT); Pierluigi TOZZI, Florence, Firenze (IT); Mattia MODA, Pisa (IT); Bernardo Disma MONELLI, Pisa (IT); Leonardo BERTINI, Pisa (IT); Matteo BENASSI, Pisa (IT)

(21) Appl. No.: 18/005,158

(22) PCT Filed: Jul. 12, 2021
(86) PCT No.: PCT/EP2021/025255

§ 371 Date: Jan. 11, 2023

(30) Foreign Application Priority Data
Jul. 15, 2020 (IT) 102020000017164

(51) Int. Cl. G06F 30/23

(52) U.S. Cl. CPC G06F 30/23; G06F 2113/10

(57) ABSTRACT

A scaling method for simulating any manufacturing process employing a moving heat source is disclosed. The method is intended to melt or sinter a material, wherein the heat source is driven according to a defined path. The method requires a meso-scale model, which evaluates the physical quantities representative of the process-induced thermal history and residual stress and strain fields for each set of process parameters employed for the given material. The meso-scale results, obtained by modeling one or multiple scan lines, are transferred to the elements of the macro-scale finite element mesh based on the defined path. The scaling is performed pointwise and followed by an averaging operation on the values of the physical quantities computed inside each element of the macro-scale finite element mesh. Finally, a macro-scale simulation is executed for evaluating the residual stresses and distortions arising throughout the entire manufacturing process.

### TECHNICAL FIELD

The present disclosure concerns a simulation method based on a pointwise superposition applicable to any manufacturing process employing a moving heat source, e.g., welding and Powder Bed Fusion (PBF). More specifically, the present disclosure concerns a scaling procedure that links a meso-scale model and a macro-scale model, as better explained below.

### BACKGROUND

In the field of 3D printing several technologies are available. For instance, the PBF comprises all the processes employing focused energy to melt or sinter powder layers.

The major manufacturing problems associated with those processes are porosity, cracks, delamination, residual stresses, and distortions. In particular, residual stresses may reduce the mechanical strength, while distortions may result in out-of-tolerance components or collisions between the part and the recoater.

Therefore, the availability of a reliable and fast simulation method would be useful and welcome in the field, in order to predict possible failures minimizing the impact of trial and error procedures.

In general, meso-scale and macro-scale models are the most suitable for investigating the effect of residual stresses, while micro-scale and particle-scale models mainly focus on microstructure, porosity, and surface roughness.

More specifically, meso-scale models are suitable to evaluate the local thermal history and residual stress and strain fields produced by the scanning process on limited volumes. Such models can be employed, in combination with thermodynamic simulations and experimental procedures, to optimize process parameters and predict how a material's microstructure may change during additive manufacturing. This is particularly important since microstructure affects the static and fatigue strength of the printed component.

On the other hand, macro-scale models consist of a thermo-structural or purely structural Finite Elements (FE) analysis that can be employed to predict part distortions, evaluate stresses, and locate possible failures throughout the entire manufacturing process.

The poor scalability of meso-scale models currently limits their use to small scanning volumes, mainly owing to computational costs. Since the scanning lengths of PBF processes typically exceed 109 times the beam diameter, a scaling procedure is desirable to overcome such limitations.

Therefore, it would be welcome in the field an efficient physics-based method to compute the initial conditions of a FE model aimed at predicting residual stresses and part distortions induced by the manufacturing process.

### SUMMARY

In one aspect, the subject matter disclosed herein is a computer implemented method for simulating a manufacturing process that employs a moving heat source, intended to melt or to sinter a material. The method comprises the implementation of a meso-scale model to calculate the physical quantities representative of the process-induced thermal history and residual stress and strain fields for a set of process parameters employed for the given material. Also, it defines a macro-scale FE model of all the parts involved in the manufacturing process, comprising a plurality of elements. Then the method implements a scaling procedure linking the meso- and macro-scale models. More specifically, it is disclosed the Pointwise Strain Superposition (PSS) method as such scaling procedure. The method computes the incompatible strain (i.e., the additive inverse of the initial elastic strain to be applied to the macro-scale model) and the initial state of the macro-scale structural model based on the results obtained from one or multiple meso-scale thermo-structural simulations, thus reducing the over-all computational cost needed to evaluate the process-induced residual stresses and part distortions. In this way, an efficient prediction of both residual stresses and part distortions induced, for example, by PBF Additive Manufacturing processes is achieved. In addition, an assessment of the manufacturability and mechanical strength of the possibly produced parts is achieved as well.

It is also disclosed herein a system for simulating a manufacturing process comprising a processing unit or a computer, with a processor operable for carrying out the computer implemented simulation method. The system can comprise a database and a device to display, print, or store the results achieved.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a flowchart of a computer-implemented simulation method that incorporates a new scaling procedure;

FIG. 2 illustrates a detailed flowchart of the simulation method of FIG. 1;

FIG. 3 illustrates a schematic representation of a meso-scale model according to a first embodiment;

FIG. 4 illustrates a 3D section of the residual von Mises equivalent stress field resulting from a meso-scale simulation of a single scan line;

FIG. 5 illustrates a cross-section of the transverse component of the residual stress field resulting from the meso-scale simulation of a single scan line;

FIG. 6 illustrates a cross-section of the longitudinal component of the residual stress field resulting from the meso-scale simulation of a single scan line;

FIG. 7 illustrates the macro-scale simulation procedure;

FIG. 8A illustrates the cantilever-shaped specimen employed to validate the simulation method, and the wire cut performed on the supports after the building process;

FIG. 8B illustrates a deformed shape of the specimen after being cut;

FIG. 9 illustrates a comparison between the simulated and measured top profile of the specimen after cutting; and

FIG. 10 illustrates a system configured to perform the computer-implemented simulation of FIGS. 1-2.

### DETAILED DESCRIPTION

A method has been conceived for simulating any manufacturing process that uses a heat source moving along a predetermined path, e.g., a welding process or an additive manufacturing process. The method processes a solid model of the workpiece to be manufactured or welded. The mechanical and thermal response of the material to the heating process is simulated by a suitable meso-scale model. Then, the results of such model are scaled to simulate the structural behavior of the entire workpiece to be manufactured (or welded), so as to predict the residual stresses and distortions generated throughout the entire process.

In general terms, the simulation method herein disclosed comprises three main steps: a meso-scale simulation, a scaling procedure, and a macro-scale simulation. The meso-scale simulation reproduces the scanning process on limited volumes, even a single scan line, and evaluates the physical quantities representative of the process-induced residual stress-strain field. Then, the scaling procedure transfers the meso-scale results to a macro-scale FE mesh according to the given scanning path. Finally, the macro-scale simulation reproduces the entire manufacturing process evaluating residual stresses and distortions of the entire workpiece. In this way, it is possible to simulate an entire process with a very limited computational cost.

In the following description and in the embodiments presented below, PBF processes are considered, but it is clear that the method herein described is not limited to this specific use.

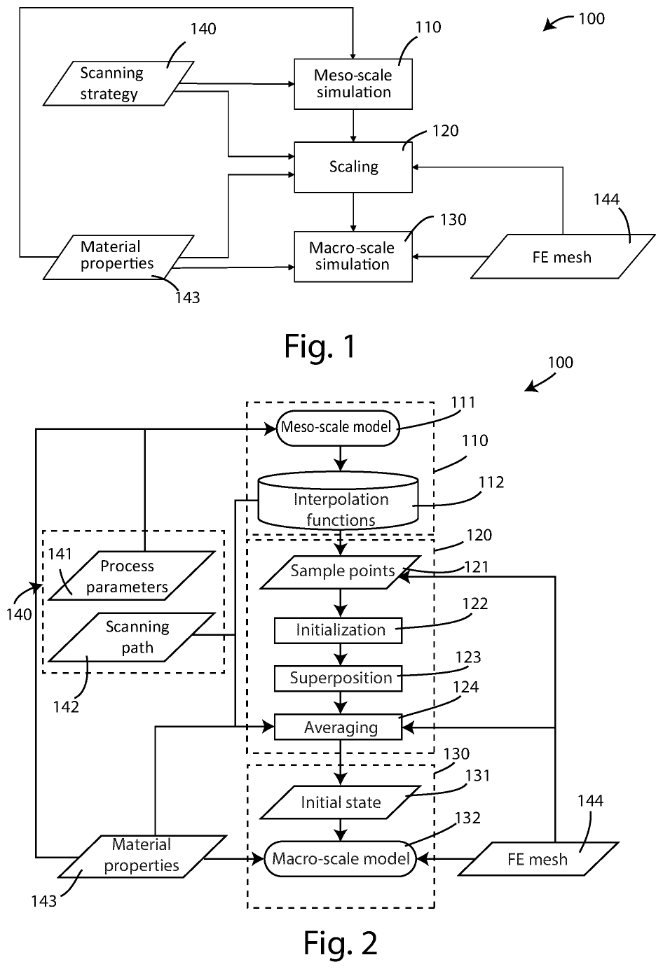

The simulation method is shown in FIG. 1 and FIG. 2, and it is wholly indicated with the reference number 100.

Referring to FIG. 1, the above mentioned three main steps of the simulation method 100 are shown, along with the input data required for executing the same. The process-related input data, referred to as scanning strategy 140, comprise the process parameters 141 and the scanning path 142, as better defined below. The material-related input data, referred to as material properties 143, comprise all the thermo-physical and mechanical properties needed by the simulation method 100. Finally, the discretization-related input data, referred to as FE mesh 144, comprise the list of the elements and node locations obtained by discretizing the solid model of the workpiece whose manufacturing process has to be simulated.

Still referring to FIG. 1 and FIG. 2, the meso-scale simulation step 110 of the simulation method 100 comprises the sub-step of calculating the process-induced thermal history and the residual stress and strain fields for each set of process parameters 141 employed for the given material 143. Also, the meso-scale simulation 110 comprises the step of storing the results in step 112.

More specifically, the meso-scale simulation step 110 receives as input the process parameters previously retrieved and read in step 141, as part of the scanning strategy 140. These parameters are the control variables of the manufacturing or welding process to be simulated, e.g., the beam power, scanning speed, beam diameter, layer thickness, and preheating temperature.

The results of the meso-scale simulation step 110 (i.e., the residual elastic strain, plastic strain, and maximum temperature fields) are sampled and used to define one or more interpolation functions. In particular, in some embodiments, the results are sampled on a plane perpendicular to the scanning direction and stored in step 112 as two-dimensional interpolation functions, by suitable storing means, which can be hardware-based (memory, hard disk or any other storing means) and/or software based.

The scaling step 120 comprises four sub-steps. The first sub-step 121 is the definition of sample points for each element of the macro-scale FE mesh 144. The second sub-step 122 is the initialization of the selected physical quantities at every sample point.

Then the values of the physical quantities (in this embodiment the incompatible strains and initial equivalent plastic strain) are calculated in sub-step 123 at each sample point. This calculation is executed following a defined path 142, which, as said, is part of the scanning strategy, and it is set beforehand. Then, the values of the physical quantities are transferred to the elements of the FE mesh 144 in the averaging sub-step 124.

In this way, the results of the meso-scale simulation 110 are scaled to each element of the macro-scale FE mesh 144, thus providing the initial state 131 of the macro-scale model 132.

The macro-scale simulation 130 reads the initial state 131 and evaluates the residual stresses and distortions generated throughout the entire manufacturing process through the macro-scale model 132.

Ultimately, the scaling step 120, which constitutes the main disclosure, links two finite element models of different length and time scale. It computes, in particular, the incompatible strain and the initial state of a macro-scale structural model based on the results obtained from a meso-scale thermo-structural model, thus reducing, as said, the overall computational cost needed to evaluate process-induced residual stresses and part distortions.

In other words, the scaling step 120 uses the results of a finer but slower simulation model, namely the above-mentioned meso-scale model 111, to define the input of a coarser but faster simulation model, namely the macro-scale model 132.

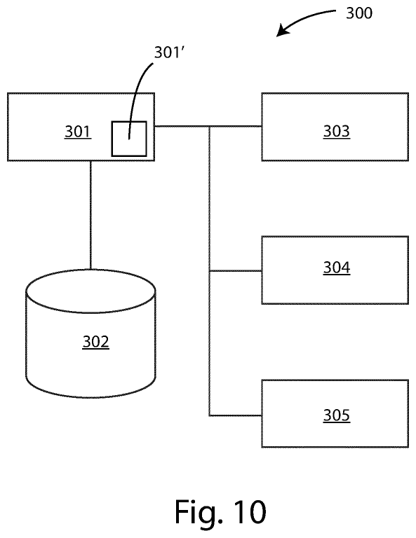

The simulation method 100 is intended to be executed by processing means or equipment, likewise a computer or any other processing equipment properly programmed to execute a software implementing the simulation method 100. An example of such equipment is shown in FIG. 10 and will be described in more detail below.

In the following, an embodiment of the simulation method 100 applied to a PBF process is described in detail. More specifically, an example of the meso-scale model of step 111 and the macro-scale model of step 132 are set forth, in order to better disclose the operation of the scaling step 120.

### 1. Meso-Scale Model

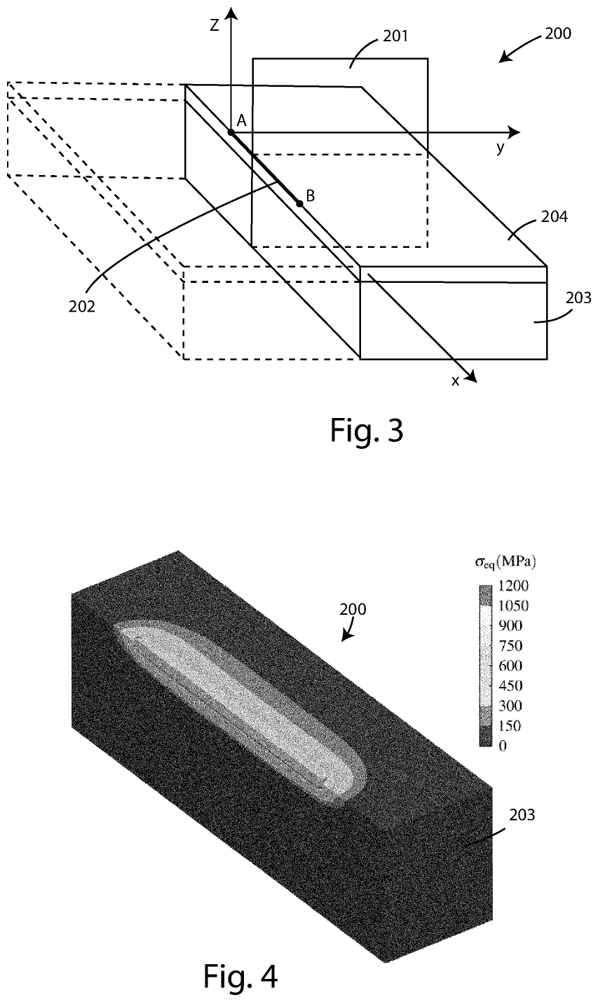

The meso-scale model of step 111 of the present embodiment evaluates the temperature, stress, and strain fields produced by a single scan line (from point A to point B of FIG. 3). It consists of a one-way coupled FE thermo-structural simulation.

The domain 200 of the meso-scale model 111 comprises a substrate 203 and one powder layer 204 as shown in FIG. 3. For ease of reference, a Cartesian coordinate system x, y, and z is provided. In particular, the z-axis is aligned with the building direction, namely the direction along which the powder layers are added, and the x-axis is aligned with the scanning direction, which is perpendicular to the sampling plane 201, in its turn parallel to the y-z plane. The single scan line 202, taken as said between the two points A and B, is parallel to the x-axis. In the domain 200 of the meso-scale model, the substrate 203 and the powder layer 204 are also shown.

The domain 200 is symmetric about the plane containing the scanning and building directions.

In the present embodiment, the thermal and structural FE equations of the meso-scale model 111 are the following:

[C_{T}]{\dot{T}}+[K_{T}]{T}={F_{q}}+{F_{g}}

[Kᵤ]{u}={Fᵤ}−[K_{uT}]{T−T_{ref}}

where:
[C_{T}] is the thermal specific heat matrix;
{T} and {\dot{T}} are the nodal temperature vector and its time derivative;
[K_{T}] is the thermal conductivity matrix;
{F_{q}} is the thermal body force vector (resulting from the integration of a moving volumetric heat source);
{F_{g}} is the thermal gradient force vector (which encompasses the effects of evaporation, radiation, convection, and the heat conducted through all the surfaces subjected to boundary condition of constant temperature);
[Kᵤ] is the structural stiffness matrix;
{u} is the nodal displacement vector;
{Fᵤ} is the structural nodal loads vector (arising from iperstatic boundary conditions);
[K_{uT}] is the thermoelastic stiffness matrix; and
T_{ref} is the reference temperature adopted for calculating the thermal strains.

In other embodiments other approximation processes or methods can be used, such as other numerical solutions or, in particular cases, even analytical solutions whenever available.

A volumetric heat source models the beam-matter interactions and advective phenomena occurring inside the melt pool, which is the region of molten material. The heat source moves from the start (point A) to the end (point B) of the scan line 202 with a speed defined by the considered set of process parameters retrieved in step 141, and it is calibrated to minimize the differences between the simulated and measured melted zone.

In other embodiments the beam-matter interactions can be modeled differently, depending on the circumstances as well as the boundary conditions.

Within the computer-implemented simulation model, melting and solidification are simulated by modifying the thermal conductivity, for the thermal simulation, and the stiffness, for the structural simulation, of the elements undergoing the phase transitions.

The nodal temperature, namely the temperature at each node of the FE mesh 144, is initialized at the preheating temperature according to the set of process parameters retrieved and read in step 141.

During the thermal simulation (see FIG. 3), the surface z=0 is subjected to evaporation, radiation, and convection. The surface y=0 is adiabatic (for symmetry), while all the other boundary surfaces are maintained at the preheating temperature.

During the structural simulation (always referring to FIG. 3), the surface z=0 is stress free, the surface y=0 is subjected to the symmetry constraint u_{y}=0, where u_{y} is the displacement in they-direction, while all the other boundary surfaces are fully constrained according to the semi-infinite hypothesis, i.e., the displacement is negligible at high distance from the scanning region.

Excluding the domain regions close to the endpoints, the thermo-structural problem is quasi-stationary. Therefore, since the considered domain 200 approaches a state of rest as time goes to infinity, the residual stress (see FIGS. 4, 5, and 6) and strain fields are invariant along the scanning direction x.

The residual stress field produced by a single scan line typically displays a tensile hydrostatic component on the surface. In response, stresses become compressive in the subsurface region to ensure self-balance.

FIG. 4 shows a 3D section of a residual von Mises equivalent stress field resulting from the meso-scale simulation of a single scan line along the x-axis on the Nickel-based alloy Inconel® 718 (Inconel is a registered trademark) according to a first embodiment. The von Mises equivalent stress is defined as follows:

$${σ}_{e q} = \sqrt{\frac{1}{2} [ {( {σ}_{1} - {σ}_{2} )}^{2} + {( {σ}_{2} - {σ}_{3} )}^{2} + {( {σ}_{1} - {σ}_{3} )}^{2} ]}$$

where σ₁, σ₂, and σ₃ are the principal stresses.

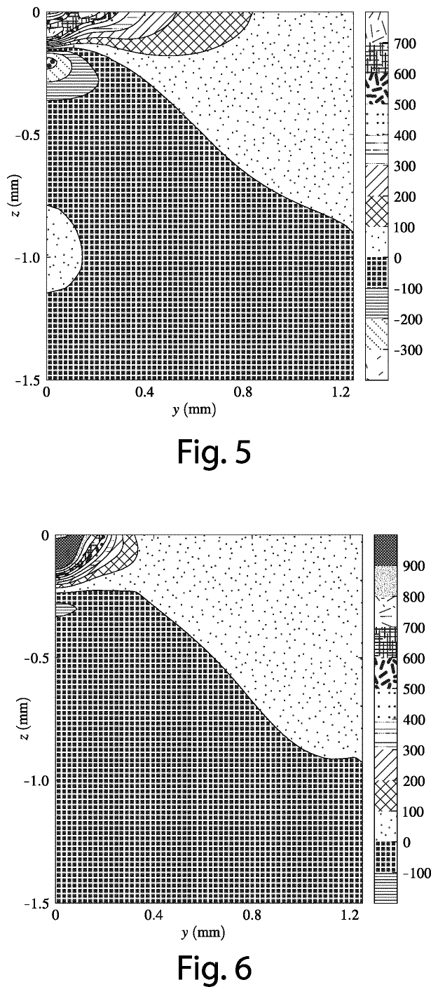

Also, FIG. 5 illustrates a cross-section of the transverse component of the residual stress field resulting from the meso-scale simulation of a single scan line along the x-axis on Inconel® 718 according to a first embodiment (values in MPa—Mega Pascal).

FIG. 6 illustrates a cross-section of the longitudinal component of the residual stress field resulting from the meso-scale simulation of a single scan line along the x-axis on Inconel® 718 according to a first embodiment (values in MPa—Mega Pascal).

### 2. Scaling Procedure

The scaling procedure 120 links the meso-scale 111 and macro-scale 132 models by defining an incompatible strain and an initial state 131 of the macro-scale simulation 130 based on the meso-scale results.

The incompatible strain is the additive inverse of the initial elastic strain to be applied to the macro-scale model 132.

A meso-scale simulation 110 of a single scan line 202 (referring again to FIG. 3) is executed with every combination of parameters 141 (e.g., power, speed, beam diameter, layer thickness) employed to process the given material 143.

The residual elastic strain ϵᵢⱼ^{(el)}, plastic strain ϵᵢⱼ^{(pl)}, and maximum temperature Tₘₐₓ fields are sampled on the plane 201 perpendicular to the scanning direction, which, in the Cartesian coordinate system of FIG. 3, is the x-axis. These results, which are physical quantities, are stored in a database 112 in the form of the three interpolation functions ϵᵢⱼ^{(el)} (p), ϵᵢⱼ^{(pl)} (p), and Tₘₐₓ(p), where p is the position on the sampling plane 201. Such interpolation functions can be recalled through the corresponding material-parameters combination.

The scaling procedure 120 starts by defining the sample points 121 inside the elements of the macro-scale FE mesh defined, with reference to FIG. 2, in step 144.

The list of scan lines is extracted from the scanning path in step 142, and each line is associated with the corresponding set of process parameters 141 (see FIG. 2). These data are stored in the three arrays (where n₁ is the total number of scan lines):
A∈ [symbol] collecting the coordinates of the start points
B∈ [symbol] collecting the coordinates of the end points
F∈ [symbol] collecting the reference to the interpolation functions of each scan line.

In this embodiment, the PSS procedure 123 computes the incompatible strain ϵᵢⱼ⁽ⁱⁿ⁾ and the initial equivalent plastic strain ϵ̅₀^{(pl)} for each sample point generated in step 121. In other embodiments, different physical quantities may be considered.

An embodiment of both the initialization step 122 and the superposition algorithm 123 is reported below in pseudocode.

| | Input: x, y, z, A, B, F, Tᵣₑₗₐₓ | |
|---|---|---|
| 1: | εᵢⱼ⁽ⁱⁿ⁾ ← 0 | [symbol] Initialization |

| | | |
|---|---|---|
| 2: | ε̅₀^{(pl)} ← 0 | |
| 3: | r ← [x y z]^{T} | |
| 4: | for l ← 1 to n₁ do | |
| 5: | a ← [Aₗ₁ Aₗ₂ Aₗ₃]^{T} | [symbol] Scan line properties |
| 6: | b ← [Bₗ₁ Bₗ₂ Bₗ₃]^{T} | |
| 7: | $n ← \frac{b - a}{‖ b - a ‖}$ | |
| 8: | f ← Fₗ | |

| | |
|---|---|
| 9: | if 0 ≤ n^{T}(r − a) ≤ ∥b − a∥ ∧ r₃ ≤ a₃ then |

| | | |
|---|---|---|
| 10: | p ← r − a − (n^{T}(r − a))n | [symbol] Projection |

| | | |
|---|---|---|
| 11: | εᵢⱼ^{(el)} ← εᵢⱼ_{_{f}}^{(el)}(p) | [symbol] Interpolation |

| | |
|---|---|
| 12: | εᵢⱼ^{(pl)} ← εᵢⱼ_{_{f}}^{(pl)}(p) |
| 13: | Tₘₐₓ ← Tₘₐₓ_{_{f}}(p) |

| | | |
|---|---|---|
| 14: | if Tₘₐₓ > Tᵣₑₗₐₓ then | [symbol] Relaxation |

| | |
|---|---|
| 15: | εᵢⱼ⁽ⁱⁿ⁾ ← 0 |
| 16: | ε̅₀^{(pl)} ← 0 |
| 17: | end if |

| | | |
|---|---|---|
| 18: | if tr (εᵢⱼ^{(el)}) > tr (−εᵢⱼ⁽ⁱⁿ⁾) then | [symbol] Incompatible strain |

| | |
|---|---|
| 19: | εᵢⱼ⁽ⁱⁿ⁾ ← −R^{T}εᵢⱼ^{(el)}R |
| 20: | end if |

| | | |
|---|---|---|
| 21: | ${\overline{ε}}_{0}^{( pl )} ← max ( {\overline{ε}}_{0}^{( pl )} , \sqrt{\frac{2}{3}} ‖ {ε}_{ij}^{( pl )} ‖ )$ | [symbol] Eq. plastic strain |

| | |
|---|---|
| 22: | end if |
| 23: | end for |
| 24: | return εᵢⱼ⁽ⁱⁿ⁾, ε̅₀^{(pl)} |

Both ϵᵢⱼ⁽ⁱⁿ⁾ and ϵ₀^{(pl)} are initialized at zero (lines 1, 2) for each sample point generated in step 121 and updated if the projection of the sample point on the considered scan line lies between and below its start and end points (line 9).

If that is the case, the sample point is projected on the plane perpendicular to the scanning direction (line 10). Then the elastic strain ϵᵢⱼ^{(el)}, plastic strain ϵᵢⱼ^{(pl)}, and maximum temperature Tₘₐₓ produced by the considered scan line are retrieved through the corresponding interpolation function 112.

A first-order approximation of ϵᵢⱼ⁽ⁱⁿ⁾ is obtained by changing the sign of the ϵᵢⱼ^{(el)} with the maximum trace (line 18) evaluated after the last relaxation (lines 14-17) and expressed in the global reference frame (line 9).

The initial equivalent plastic strain is approximated (line 21) by the maximum ϵ̅^{(pl)} computed after the last relaxation (lines 14-17) as:

$${\overline{ε}}^{( pl )} = \sqrt{\frac{2}{3} {ε}_{i j}^{( pl )} : {ε}_{i j}^{( pl )}} = \sqrt{\frac{2}{3}} ‖ {ε}_{ij}^{( pl )} ‖$$

The incompatible and initial equivalent plastic strains are transferred to the elements of the macro-scale mesh 144 by averaging (step 124) the values computed at the sample points inside each element of the above mesh:

$$\{ \begin{matrix}{[ {ε}_{ij}^{( i n )} ]}_{e}^{( e )} = \frac{1}{{n}_{e}} {\sum }_{r ε {Ω}_{e}} {ε}_{i j}^{( i n )} ( r ) \\ {\{ {\overline{ε}}_{0}^{( pl )} \}}_{e}^{( e )} = \frac{1}{{n}_{e}} {\sum }_{r ε {Ω}_{e}} {\overline{ε}}_{0}^{( pl )} ( r )\end{matrix}$$

where nₑ is the number of sample points generated in step 121 belonging to the element domain Ωₑ.

### 3. Macro-Scale Model

The macro-scale simulation 130, consisting of a structural FE simulation, estimates the displacement field and all the derived quantities throughout the entire building process.

The part volume is sliced with planes perpendicular to the build direction.

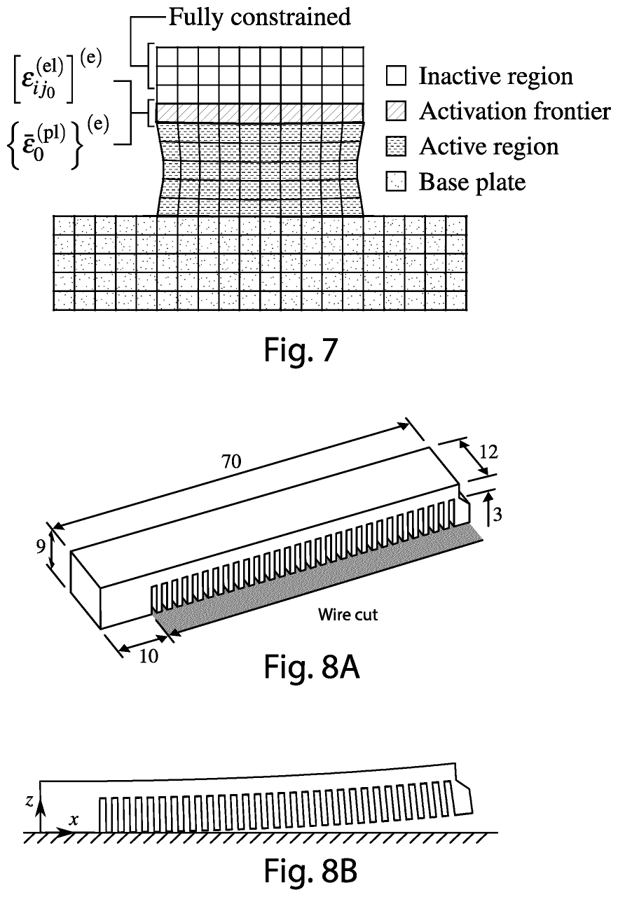

Referring to FIG. 7, all the elements belonging to the manufactured part are initially deactivated, namely, their stiffness is made negligible with respect to its original value. Then, the slices are activated sequentially by restoring the original stiffness of their elements.

The activated elements receive the initial elastic strain

$${[ {ε}_{{ij}_{0}}^{( el )} ]}^{( e )} = - {[ {ε}_{ij}^{( i n )} ]}^{( e )}$$

and the initial equivalent plastic strain {ϵ̅₀^{(pl)}}^{(e)} (see step 131) defined by the PSS procedure 123 in the scaling step 120.

The structural FE equations to be solved are of the following form

[Kᵤ]{u}={Fᵤ}−[K_{uT}]{T−T_{ref}}

where:
[Kᵤ] is the structural stiffness matrix;
{u} is the nodal displacement vector;
{Fᵤ} is the structural nodal loads vector (arising from iperstatic boundary conditions);
[K_{uT}] is the thermoelastic stiffness matrix;
{T} is the nodal temperature vector; and
T_{ref} is the reference temperature adopted for calculating the thermal strains.

The base plate is constrained, at least isostatically, to prevent rigid motions during the building process.

All the nodes not belonging to the active elements are fully constrained (see FIG. 7) to maintain the top surface of each slice at its nominal shape and size until activation.

### 4. Validation of the Simulation Method

The simulation method 100 has been tested on the cantilever-shaped specimen represented in FIG. 8A and in FIG. 8B. The specimen was manufactured in selective laser melted Inconel® 718. The supports were wire cut before measuring the top profile with 3D scan.

The wire cut causes the cantilever to bend (FIG. 8B) due to the x-z stress gradients generated during the building process.

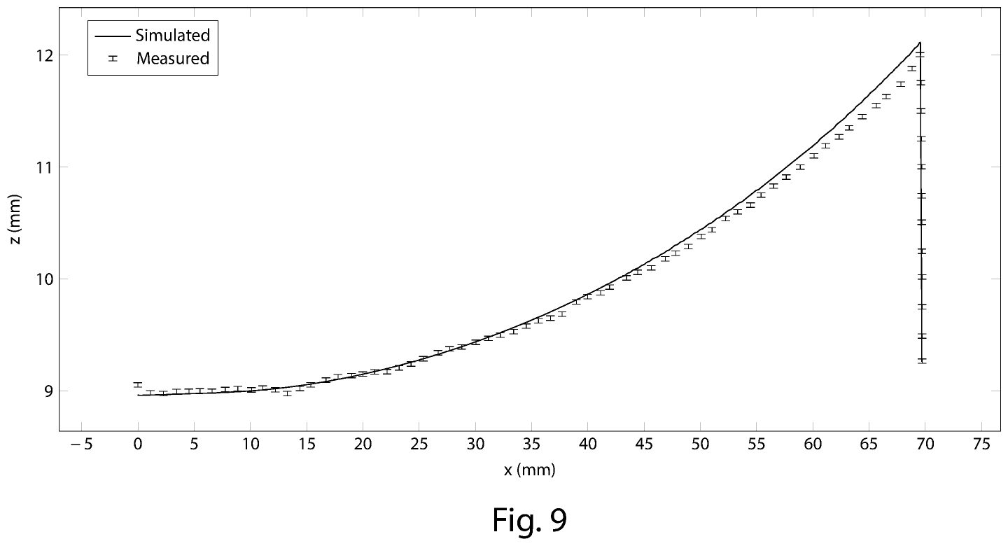

The comparison between the simulated and measured top profile is shown in FIG. 9. Overall, the simulation overestimates the upwards displacement with a maximum absolute error of 0.2 mm. This accuracy is comparable to the fluctuation of the measured data between different specimens.

Since the cantilever distortion after the support removal is mainly driven by the release of bending stresses accumulated during the building process, the simulation method seems to correctly reproduce the stress field throughout the top flange of the specimen.

### 5. Conclusions

The method 100 can be applied for simulating any manufacturing process employing a moving heat source, such as welding, Direct Energy Deposition, Laser Metal Deposition, Fused Deposition Modeling, PBF, and other additive manufacturing processes.

The PSS procedure 123 is either equivalent or more efficient than similar structural scaling strategies. In fact, it requires the meso-scale model step 111 of a single scan line 202, while other methods simulate one or more layers 204. Moreover, the PSS procedure 123 resulted faster than all simulation strategies that execute a full-scale thermal analysis. This saves computational resources, also increasing the processing speed.

Referring now to FIG. 10, a system 300 for carrying out the method 100 is illustrated. The system 300 comprises a computer or a processing unit 301, provided with a processor 301′, configured to execute the method 100 and simulating, for instance, a production or a welding process by means of a moving heat source, wherein the heat source is driven according to a manufacturing path. The computer 301 is operable for executing a computer program that performs the simulation method.

The software implementing the simulation method 100 can be executed by different computer systems. For example, a common laptop (HP®, ThinkPad®, Apple®, or the like) with an Intel® or AMD° processor can be used, equipped with a suitable RAM memory package, such as, just by way of example, a 1 GB RAM.

Also, a server can be used, which can be installed on site or be cloud-based. In addition, owing to the fact that processing means are required, a computer network, even remote with respect to the place where the processing is launched, can be employed. Further, handheld devices, such as tablets or smartphones, properly programmed, can be used, in principle, to execute the simulation method 100. In theory, even quantum computers or any other processing means can be programmed in order to process the simulation method 100.

As to the software language used to implement the simulation method, compiled languages, such as C++, Fortran and the like, should be preferable, but even interpreted languages, such as Python, Java and the like, may be suitable depending on the specific case.

The system 300 comprises also a database 302 configured to store the interpolation functions 112. The database 302 may be hardware-based (memory, hard disk or any other storing means) and/or software-based, and it is coupled with the computer processor. The interpolation functions can be recalled from the database 302 through the corresponding material-parameters combination.

The system 300 also comprises devices for a display 303, a printer 304, and additional storing means 305 to store the results of the computations, all connected to the computer 301 and controlled by it. Such devices are configured to show the results of the simulation.

An advantage of the solution is that it allows a physics-based simulation of significant scanning volumes with a reasonable computational cost.

In addition, it is an advantage of the solution herein disclosed the fact that it is minimized the number of scan-path dependent configurations explored at the mesoscale level.

It is also an advantage of the simulation method according to the present disclosure the fact that it allows to reduce the number of trial and error procedures currently employed for product development.

While aspects of the invention have been described in terms of various specific embodiments, it will be apparent to those of ordinary skill in the art that many modifications, changes, and omissions are possible without departing form the spirit and scope of the claims. In addition, unless specified otherwise herein, the order or sequence of any process or method steps may be varied or re-sequenced according to alternative embodiments.

Reference has been made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment or “in an embodiment” or “in some embodiments” in various places throughout the specification is not necessarily referring to the same embodiment(s). Further, the particular features, structures or characteristics may be combined in any suitable manner in one or more embodiments.

When elements of various embodiments are introduced, the articles “a”, “an”, “the”, and “said” are intended to mean that there are one or more of the elements. The terms “comprising”, “including”, and “having” are intended to be inclusive and mean that there may be additional elements other than the listed elements.

1. A computer implemented method for simulating a manufacturing process employing a moving heat source, intended to melt or to sinter a material, wherein the heat source is driven according to a predefined path, wherein the method comprises the steps of:
reading a plurality of process parameters for performing the manufacturing process;
reading the material properties for simulating the manufacturing process;
calculating through a meso-scale model the physical quantities representative of the process-induced thermal history and residual stress and strain fields for each set of process parameters employed for the given material;
defining a macro-scale finite element mesh of all the parts involved in the manufacturing process, comprising a plurality of elements; and scaling the meso-scale results to the macro-scale FE mesh based on the defined path, wherein the scaling step also comprises the steps of calculating the value of the physical quantities at one or more sample points of each element of the FE mesh, based on the defined path, and averaging the values of the physical quantities computed in-side each element of the macro-scale FE mesh; and
executing a macro-scale simulation, for determining the displacements and all the derived quantities throughout the entire manufacturing process.

2. The method according to claim 1, wherein the meso-scale model determines the physical quantities on length scales comparable to the size of the heat source.

3. The method according to claim 1, wherein the physical quantities are obtained from the meso-scale simulation of a single scan line.

4. The method according to claim 1, wherein the physical quantities are sampled or calculated on a plane perpendicular to the moving direction of the heat source.

5. The method according to claim 3, wherein the physical quantities are employed to define one or more interpolation functions.

6. The method according to claim 5, wherein the interpolation functions compute the elastic strain, plastic strain, and maximum temperature based on the position with respect to the scan line.

7. The method according to claim 5, comprising the step of storing the interpolation functions in storage means.

8. The method according to claim 1, wherein, before the step of calculating the value of the physical quantities at each sample point of the elements of the FE mesh, the scaling procedure further comprises the steps of:
defining one or more sample points for each element of the macro-scale FE mesh; and
initializing the value of the physical quantities at every sample point, preferably at zero.

9. The method according to claim 1, wherein the sample points are distributed either randomly or regularly.

10. The method according to claim 1, wherein the heat source is an electromagnetic beam, such as a laser, or an electron beam, and wherein the material is a powder to be layered.

11. The method according to claim 1, wherein the process parameters comprise one or more of the following parameters:
a laser or electron, a scanning speed, a beam diameter, a layer thickness, a preheating temperature, and a build chamber atmosphere.

12. A system for simulating a manufacturing process employing a moving heat source, intended to melt or to sinter a material, wherein the heat source is driven according to a predefined path; the system comprising:
a processing unit or a computer comprising at least one processor operable for executing a computer program carrying out the steps according to claim 1;
a database configured to store the interpolation functions; and
at least one device to display, print, or store the results of the macro-scale simulation.

13. A computer program, comprising instructions which, when the program is executed by a computer, cause the computer to carry out the steps of the method of claim 1.

14. A computer-readable storage medium, comprising the instructions which, when executed by a computer, cause the computer to carry out the steps of the method of claim 1.
